(19) United States
(12) Patent Application Publication
(10) Pub. No.: US 2023/0002651 A1
(43) Pub. Date: Jan. 5, 2023

(54) HOT MELT PRESSURE SENSITIVE ADHESIVES BASED ON ETHYLENE-ACRYLATE BLOCK COPOLYMERS

(71) Applicant: Bostik, Inc., Wauwatosa, WI (US)

(72) Inventors: Kathleen M. Davis, Brookfield, WI (US); Michael D. Vitrano, West Allis, WI (US); Patrick J. Czaplewski, New Berlin, WI (US); Lauren M. Rohde, Milwaukee, WI (US)

(21) Appl. No.: 17/782,181

(22) PCT Filed: Dec. 4, 2020
(86) PCT No.: PCT/US2020/063331

§ 371 Date: Jun. 3, 2022

Related U.S. Application Data
(60) Provisional application No. 62/944,486, filed on Dec. 6, 2019.

(51) Int. Cl. C09J 153/00; C09J 5/06; C08F 220/06; C08F 210/02

(52) U.S. Cl. CPC C09J 153/00; C09J 5/06; C08F 220/06; C08F 210/02

(57) ABSTRACT

A hot melt pressure sensitive adhesive composition comprises: (a) a block copolymer comprising a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min; (b) a tackifying resin; and (c) a plasticizer. A method for making a laminate comprises the steps of: applying the hot melt pressure sensitive adhesive composition of the invention in a molten state to a primary substrate and allowing the adhesive to cool to form a bond with said primary substrate. Certain adhesives the invention perform comparably to certain styrene block copolymer adhesives, but provides an alternative polymer source.

### FIELD OF THE INVENTION

This invention relates to a hot melt pressure sensitive adhesive compositions based on ethylene-acrylate block copolymers for use on a wide range of substrates and providing excellent adhesive performance at both high and low temperatures.

### BACKGROUND OF THE INVENTION

Hot melt adhesives typically exist as a solid mass at ambient temperature and can be converted to a flowable liquid by the application of heat. Pressure sensitive hot melt adhesives are tacky at room temperature and are useful in a wide variety of applications, such as for tape and label, rigid or flexible packaging, nonwoven hygiene articles, paper products, automotive and other transportation application, and appliances. In most of these applications, the hot melt adhesive is heated to its molten state and then applied to a substrate, often named as the primary substrate. For preparation of a tape or label, often only a primary substrate is used. In other applications, a second substrate, often named as the secondary substrate, is then immediately brought into contact with and compressed against the first. The adhesive solidifies on cooling to form a strong bond. A major advantage of hot melt adhesives is the absence of a liquid carrier, as would be the case of water or solvent based adhesives, thereby eliminating the costly process associated with water or solvent removal.

Over the years, adhesive formulators have utilized a variety of different polymers as well as other additives in their formulations to obtain a balance of these attributes (adhesion, creep resistance, flexibility, and heat environmental resistance). These polymers include, but are not limited to, polyolefins (ethylene- or propene-based polymers), functionalized polyolefins (ethylene or propene copolymers with oxygen containing monomers), or APAOs (ethylene-, propene-, or butene copolymers). Some of these polymers are crystalline and can lead to adhesives which exhibit blocking. Blocking is defined as the undesired adhesion of a coated adhesive to substrates it comes into contact with during shipping and/or storage.

In addition to ethylene vinyl acetate (EVA) polymers, other polymers have also been utilized in an attempt to improve an adhesive's hot tack and adhesion characteristics. These polymers include, but are not limited to, random copolymers of ethylene methyl acrylate copolymers (EMA), ethylene n-butyl acrylate (EnBA), and ethylene methyl acrylate acrylic acid copolymers. These polymers exhibit narrower poly-dispersity when compared to olefin polymers, such as APAO and have lower overall melt peaks as observed by DSC (Differential Scanning calorimetry). This results in an adhesive that is prone to blocking or bond failure at elevated temperatures if not reinforced with some other crystalline additive. While the incorporation of certain waxes or other crystalline additives can increase the elevated temperature resistance of the adhesive, they can reduce the adhesive's hot tack, adhesion, and flexibility.

Hot melt adhesives typically comprise a polymer, a plasticizer, a tackifying resin, and an antioxidant package. Other ingredients, such as waxes, fillers, colorants, and UV absorbers, can also be used to modify the adhesive properties or to provide special attributes. These ingredients are prone to heat degradation under the coating conditions of the adhesive. For example, a widely used commercial hot melt adhesive based on styrene-isoprene-styrene (SIS) triblock copolymer, when subjected to 175° C. for 24 hours, can suffer from a viscosity drop of about 50 percent from its original value. A styrene-butadiene-styrene (SBS) based hot melt may cause problems by crosslinking under similar conditions. Crosslinking can result in a dramatic increase in viscosity and may eventually render the adhesive un-flowable by the formation of a three dimensional polymer network. The viscosity change is often accompanied by charring, gelling, and formation of skin on top of the molten material. The degradation will inevitably lead to deterioration of the adhesive properties and performance. In addition, this degradation can also lead to equipment damage. The rate of degradation is temperature dependent; the higher the temperature, the faster the degradation. Thus, reducing the coating temperature of the adhesive can slow down degradation.

Hot melt adhesives may be applied to a substrate in a number of ways, such as by directly coating. Besides directly coating, several indirect or noncontact coating methods, through which a hot melt adhesive can be spray coated with the aid of compressed air onto a substrate from a distance, are also developed. These non-contact coating techniques include conventional spiral spray and various forms of melt-blown methods. Indirect coating methods, however, require that the viscosity of the adhesives must be sufficiently low, usually in the range of 2,000 to 30,000 mPa s, preferably in the range of 2,000 to 15,000 mPa s, at the application temperature in order to obtain an acceptable coating pattern. Many other physical factors, especially the rheological properties of the adhesive, come into play in determining the sprayability of a hot melt. The majority of commercial hot melt products do not lend themselves to spray applications. There are no accepted theoretical models or guidelines to predict sprayability, which must be determined empirically with application equipment.

There remains a need in the art to develop a hot melt a pressure sensitive adhesive which performs comparably to styrene block copolymer adhesives, but provides an alternative polymer source. In addition, there remains a further need in the art to develop a hot melt pressure sensitive adhesive which performs comparably to polyolefin-based hot melt adhesives for pressure sensitive applications but does not experience a drop in tack with time.

### SUMMARY OF THE INVENTION

In view of the needs in the art outlined above and according to an embodiment of the invention, a hot melt pressure sensitive adhesive composition comprises: (a) a block copolymer comprising a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min, preferably between about 0.1 and about 200 g/10 min, more preferably between about 0.5 and about 100 g/10 min, and most preferably between about 1 and about 50 g/10 min; (b) a tackifying resin; and (c) a plasticizer.

According to another embodiment of the invention, a method for making a laminate comprises the steps of: applying the hot melt pressure sensitive adhesive composition of the invention in a molten state to a primary substrate; and allowing the adhesive to cool to form a bond with said primary substrate. Another embodiment of the invention is directed to a laminate made by thereby.

Other features and advantages of the invention may be apparent to those skilled in the art upon reviewing the following drawings and description thereof.

### DETAILED DESCRIPTION OF THE INVENTION

According to an embodiment of the invention, a hot melt pressure sensitive adhesive composition comprises: (a) a block copolymer comprising a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min, preferably between about 0.1 and about 200 g/10 min, more preferably between about 0.5 and about 100 g/10 min, and most preferably between about 1 and about 50 g/10 min; (b) a tackifying resin; and (c) a plasticizer, and, optionally, other additives.

When upper and lower limits of ranges of a property or concentration of a constituent or of the adhesive or otherwise are set forth herein, any range extending from any lower limit to any upper limit is presumed to be contemplated by the present invention, as well as any range extending from any lower limit or any range extending from any upper limit. Therefore, the embodiments of the present invention include a block copolymer having a melt index of between about 0.1 and about 50 g/10 min and between about 0.5 and about 250 g/10 min.

The block copolymer of the present invention may have a structure of formula (I):

[P1ₐ-P2_{b}]ₙ (I)

wherein P1 is the first polymer block, P2 is the second polymer block, a indicates the number of the first polymer blocks within the structural unit [P1ₐ-P2_{b}], b indicates the number of the second polymer blocks within the structural unit [P1ₐ-P2_{b}], and n indicates the number of the structural units within the block copolymer. The molar ratio a:b of these two polymer blocks P1 and P2 may vary over a wide range, such as between about 1:9 and about 9:1, preferably between about 1:4 and about 4:1, and most preferably about 3:7 and about 7:3. Preferably, the C₁ to C₄ alkyl acrylate is selected from the group consisting of methyl acrylate and butyl acrylate. Alternatively, the adhesive composition may comprise two or more block copolymers comprising a first polymer block comprising an ethylene residue and a second polymer block comprising a C₁ to C₄ alkyl acrylate residue. In one embodiment, the block copolymer comprises a first block copolymer wherein the C₁ to C₄ alkyl acrylate is methyl acrylate and a second block copolymer wherein the C₁ to C₄ alkyl acrylate is butyl acrylate. The weight ratio of these two block copolymers may vary over a wide range, such as between about 1:9 and about 9:1, preferably between about 1:4 and about 4:1, and most preferably about 3:7 and about 7:3. As used herein, a “residue” of a compound is the monomer, such as ethylene, as it exists in its polymerized form.

The content of the alkyl acrylate comonomer may vary over a wide range. The block copolymer preferably comprises primarily ethylene residue, preferably in an amount of at least 45 wt %, preferably at least 50 wt %, more preferably at least 60 wt %, and most preferably at least about 65 wt %. In embodiments in which the C₁ to C₄ alkyl acrylate is methyl acrylate, the block copolymer comprises methyl acrylate residue in an amount of between about 7.5 and about 35 wt %, preferably between about 10 and about 30 wt %, and most preferably between about 24 and about 30 wt %. In embodiments in which the C₁ to C₄ alkyl acrylate is butyl acrylate, the block copolymer comprises butyl acrylate residue in an amount of between about 15 and about 40 wt %, preferably between about 17 and about 35 wt %, and most preferably between about 27 and about 35 wt %.

The block copolymers of the present invention have two distinct domains, each formed of a block of its respective monomer, such as ethylene or C₁ to C₄ alkyl acrylate. This forms a heterogeneous product, which can be viewed as alkyl acrylate residue domains in an ethylene residue matrix. This product may be contrasted with a homogeneous product having a regular or random distribution of a C₁ to C₄ alkyl acrylate residue in an ethylene matrix. Such products may be made using a tubular reactor and are commercially available under the trademarks Lotryl® 29MA03T and Lotryl® 35BA40T from SK Global Chemical.

For purposes of the present invention, the block copolymers have a melt index as measured in accordance with ASTM D1238 of between about 0.1 and about 250 g/10 min using a 2.16 kg weight and at a temperature of 190° C. Preferably, the melt index of each block copolymer is between about 0.1 and about 200 g/10 min, more preferably between about 0.5 and about 100 g/10 min, and most preferably between about 1 and about 50 g/10 min.

A range of other properties of the block copolymers used in the present invention may be important to achieve the purposes of the invention. Preferably, the density of the block copolymer of the present invention may be between about 0.89 and 0.97, preferably between about 0.91 and 0.96, and most preferably between about 0.93 and 0.95 g/cm³, as determined in accordance with ASTM 1505. Preferably, the melting point of the block copolymer is between about 70° C. and about 105° C., preferably between about 80° C. and about 100° C., and most preferably between about 85° C. and about 95° C., as determined in accordance with ISO 11357-3. In another embodiment, the melting point of the block copolymer is between about 15° C. and about 45° C., preferably between about 20° C. and about 40° C., and most preferably between about 25° C. and about 35° C. greater than an analogous non-block copolymer, as determined in accordance with ISO 11357-3. As used herein, an analogous non-block copolymer refers to a block copolymer which is made of the same monomers in the same amounts but does not have two or more distinct domains or regions, but instead has a random or regular distribution of one monomer residue in a matrix of the other monomer residue. The Vicat softening point of the block copolymer is less than about 55° C., preferably less than about 50° C., and most preferably less than about 40° C., as determined in accordance with ASTM D1525, with the specimen being compression molded. The flexural modulus of the block copolymer may be between about 9 MPa and 18 MPa, preferably between about 10 MPA and 15 MPa, and most preferably between about 11 MPa and 13 MPa, as determined in accordance with ASTM 0790 (1). The tensile strength at break of the block copolymer may be between about 7 MPa and 14 MPa, preferably between about 8 MPA and 12 MPa, and most preferably between about 8.5 MPa and 11 MPa, as determined in accordance with ASTM 638 (1).

As mentioned above, the adhesive composition of the invention comprises, in addition to the block copolymer described above, a tackifying resin (also referred to herein as a “tackifier”). The tackifier may be a molecule or a macro-molecule or a fairly low molecular weight polymer, compared to common polymers, from a natural source or from a chemical process or combination thereof that in general enhances the adhesion of a final hot melt pressure sensitive adhesive composition. Representative resins include the C₅/C₉ hydrocarbon resins, synthetic polyterpenes, rosin, rosin esters, natural terpenes, and the like. More particularly, the useful tackifying resins include any compatible resins or mixtures thereof such as (1) natural and modified rosins including gum rosin, wood rosin, tall oil rosin, distilled rosin, hydrogenated rosin, dimerized rosin, and polymerized rosin; (2) glycerol and pentaerythritol esters of natural and modified rosins, including the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; (3) copolymers and terpolymers of natural terpenes, such as styrene/terpene and alpha methyl styrene/terpene; (4) polyterpene resins generally resulting from the polymerization of terepene hydrocarbons, such as the bicyclic monoterpene known as pinene, in the presence of Friedel-Crafts catalysts at moderately low temperatures; also included are the hydrogenated polyterpene resins; (5) phenolic modified terpene resins and hydrogenated derivatives thereof such, for example, as the resin product resulting from the condensation, in an acidic medium, of a bicyclic terpene and a phenol; (6) aliphatic petroleum hydrocarbon resins resulting from the polymerization of monomers consisting primarily of olefins and diolefins; also included are the hydrogenated aliphatic petroleum hydrocarbon resins; and (7) cyclic petroleum hydrocarbon resins and the hydrogenated derivatives thereof. Mixtures of two or more of the above described tackifying resins may be required for some formulations. Also included are the cyclic or acylic C₅ resins and aromatic modified acyclic or cyclic resins.

In an embodiment of the invention, the tackifier is selected from the group consisting of aliphatic and cycloaliphatic hydrocarbon resins and their hydrogenated derivatives, hydrogenated aromatic hydrocarbon resins, aromatically modified aliphatic or cycloaliphatic resins and their hydrogenated derivatives, polyterpene and styrenated polyterpene resins and mixtures thereof. In another embodiment of the invention, the tackifier is selected from the group consisting of a C₅ aliphatic hydrocarbon resin, a hydrogenated C₅ resin, a hydrogenated C₉ resin, a hydrogenated DCPD resin and an aromatic-modified DCPD resin.

The hot melt pressure sensitive adhesive composition of the present invention also includes a plasticizer. Plasticizers may be used in the present invention to control the behavior of the adhesive during formulating, application, and end-use. The plasticizer component useful in the present invention may be selected from any of the mineral based oils, petroleum based oils, liquid resins, liquid elastomers, polybutene, polyisobutylene, phthalate, and benzoate plasticizers, and epoxidized soya oil. Preferably, the plasticizer is selected from the group consisting of mineral oil and liquid polybutene, and even more preferably mineral oil with less than 30% aromatic carbon atoms. A plasticizer is broadly defined as a typically organic composition that can be added to the adhesive composition to improve extrudability, flexibility, workability, and stretchability in the finished adhesive. Any material which flows at ambient or application temperatures and is compatible in the compositions of the present invention may be useful. Preferably, the plasticizer has low volatility at temperatures of greater than about 40° C. The most commonly used plasticizers are oils which are primarily hydrocarbon oils, low in aromatic content and are paraffinic or naphthenic in character. The oils are preferably low in volatility, are transparent, and have little color and negligible odor. This invention also may include olefin oligomers, low molecular weight polymers, synthetic hydrocarbon oils, vegetable oils and their derivatives and similar plasticizing oils. Solid plasticizers may also be useful to the present invention. Examples of such plasticizers include 1,4-cyclohexane dimethanol dibenzoate, glyceryl tribenzoate, pentaerythritol tetrabenzoate, and dicylcohexylphthalate. Preference is given to the petroleum based oils with suitable naphthenic minerals oils useful in this invention of the types herein described above are commercially available from Nynas, under the trade name Nyplast®. Suitable liquid plasticizers include polybutene such as Indopol series materials supplied by Ineos. As required, blends of plasticizers can also be employed to adjust end use performance and final properties.

According to embodiments of the present invention, the plasticizer is included and is selected from the group consisting of mineral oil, synthetic oils, low molecular weight polymers, and liquid polybutene.

In an embodiment of the invention, the plasticizer and the tackifier have a polarity adapted to selectively be miscible with the first polymer block, namely the polymer block comprising an ethylene residue. For example, the Hildebrand solubility parameters of the plasticizer and the tackifier may be between about 7.5 and about 8.75 cal^{1/2} cm^{-3/2}, preferably between about 7.75 and about 8.75 cal^{1/2} cm^{-3/2}, and most preferably between about 8.0 and about 8.5 cal^{1/2} cm^{-3/2}. Such adhesives may lead to improved adhesive performance on non-polar substrates. In this embodiment, the tackifier is selected from the group consisting of a hydrogenated C₅ aliphatic resin and an unhydrogenated C₅ aliphatic resin. Such tackifiers are commercially available as Piccotac 1095 and Eastotack H-100R from Eastman Chemical Company. In this embodiment, the plasticizer is generally non-polar and has a polarity similar to the polarity of the first polymer block. In this embodiment, the plasticizer may be selected from the group consisting of an isobutylene/butene copolymer and a mineral oil comprising non-polar aliphatic and alicyclic hydrocarbons. An exemplary isobutylene/butene copolymer is Indopol H-100, commercially available from Palmer Holland. Typical mineral oils Hydrobrite 550, which consists of aliphatic and alicyclic nonpolar hydrocarbons and is commercially available from Sonneborn LLC; and Kaydol, a white mineral oil and also commercially available from Sonneborn LLC.

In preferred embodiment of the invention, the plasticizer and the tackifier have a polarity adapted to selectively be miscible with the second polymer block, namely the polymer block comprising an alkyl acrylate residue. For example, the Hildebrand solubility parameters of the plasticizer and the tackifier may be within a between about 8.5 and about 10.5 cal^{1/2} cm^{-3/2}, preferably between about 8.5 and about 9.5 cal^{1/2} cm^{-3/2}, and most preferably between about 8.75 and about 9.25 cal^{1/2} cm^{-3/2}. Such adhesives appear to show better compatibility among the ingredients of the adhesive. This is surprising in view of the fact that the alkyl acrylate block is present to a lesser extent in the block copolymer than the ethylene block. Such adhesives have shown better high temperature resistance; they have a higher shear adhesive failure temperature. In this embodiment, the tackifier comprises a rosin ester. More particularly, the tackifier may have resin acids and rosin acids and esters, along with pentaerythritol. Such tackifiers are commercially available as Sylvalite RE 100L from Kraton Corporation. In this embodiment, the plasticizer is generally polar and has a polarity similar to the polarity of the second polymer block. In this embodiment, the plasticizer may comprise a benzoate ester (or dibenzoates). The plasticizer might consist solely of pure benzoate esters or could be primarily made of benzoate esters. The plasticizer could be or include di(propylene glycol) dibenzoate. Alternatively, the plasticizer could be or include a mixture of di(propylene glycol) dibenzoate and di(ethylene glycol) dibenzoate. Exemplary plasticizers in this embodiment include Benzoflex 9-88 and Benzoflex 50, commercially available from Eastman Chemical Company.

The hot melt pressure sensitive adhesive of the present invention may also include a stabilizer or an antioxidant in an amount of from about 0.1% to about 5% by weight of the adhesive composition. Preferably, from about 0.1% to 2% of a stabilizer or antioxidant is incorporated into the composition. The stabilizers which are useful in the hot melt pressure sensitive adhesive compositions of the present invention are incorporated to help protect the polymers noted above, and thereby the total adhesive system, from the effects of thermal and oxidative degradation which normally occur during the manufacture and application of the adhesive as well as in the ordinary exposure of the final product to the ambient environment. Among the applicable stabilizers are hindered phenols and multifunction phenols, such as sulfur and phosphorous-containing phenols. Antioxidants, such as hindered amine phenols, may be characterized as phenolic compounds that also contain bulky radicals in close proximity to the phenolic hydroxyl group thereof and are preferred. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency and correspondingly, its reactivity; this steric hindrance thus provides the phenolic compound with its stabilizing properties.

It should be understood that other optional, auxiliary additives may be incorporated into the adhesive composition of the present invention in order to modify particular physical properties. These may include, for example, such materials as ultraviolet light (UV) absorbers, waxes, surfactants, inert colorants, titanium dioxide, fluorescing agents and fillers. Typical fillers include talc, calcium carbonate, clay silica, mica, wollastonite, feldspar, aluminum silicate, alumina, hydrated alumina, glass microspheres, ceramic microspheres, thermoplastic microspheres, baryte and wood flour and may be included in an amount up to 60% by weight, and preferably between 1 and 50% by weight.

In an embodiment of the invention, the hot melt pressure sensitive adhesive composition does not include a wax. In embodiments of the invention in which wax is included, waxes may be included in the amount up to 20% by weight, preferably between 0.1% and 18% by weight. The wax may be selected from the group consisting of petroleum waxes, low molecular weight polyethylene and polypropylene, synthetic waxes and polyolefin waxes and mixtures thereof. In preferred embodiments, the wax is a low molecular weight polyethylene having a number average molecular weight of about 400 to about 6,000 g/mol. According to embodiments of the present invention, the adhesive composition further comprises a wax. In embodiments, the wax is present in an amount of between about 0.1% and about 20% by weight.

In embodiments of the invention, the hot melt pressure sensitive adhesive composition comprises, consists essentially of, or consists of: a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min; a tackifying resin; and a plasticizer; and, optionally, one or more of the following: a stabilizer, a nucleating agent, a wax, and the auxiliary additives mentioned herein.

The amounts of the various constituents may vary over a wide range, depending on the desired application, the desired application temperature, and other conditions and the desired performance characteristics of the adhesive. The invention includes any combination of any range of one constituent with any range or an unlimited amount of another constituent or both other constituents. According to embodiments of the invention, the adhesive comprises the following constituents in the following amounts:
the block copolymer present in an amount of between about 15% and about 40%, preferably between about 20% and about 35%, more preferably between about 22% and about 32%, and most preferably between about 25% and about 30%, by weight;
the tackifying resin present in an amount of between about 30% and about 75%, preferably between about 35% and 70%, more preferably between about 38% and 60%, and most preferably between about 40% and about 55%, by weight; and
the plasticizer present in an amount of between about 5% and about 40%, preferably between about 10% and about 35%, more preferably between about 15% and 30%, and most preferably between about 18% and about 27%.

The viscosity of the adhesive of the present invention may vary over a wide range, depending on the application, in a known way. The viscosity of the adhesive material according to the present invention should be generally at a viscosity at the application temperature appropriate to be processed and applied to its substrate. An adhesive with relatively low viscosity at a low application temperature is needed to be processed through standard hot melt pressure sensitive adhesive equipment and to achieve the desired pattern and consequently suitable bonding performance at the application temperature. According to preferred embodiments of the present invention, the viscosity of the composition is between about 1,000 cP and about 250,000 cP at 163° C., preferably between about 2,000 cP and about 150,000 cP at 163° C., more preferably between about 3,000 cP and about 100,000 cP at 163° C., and most preferably between about 4,000 cP and about 50,000 cP at 163° C. The viscosity of an adhesive composition as described herein is measured by ASTM D3236.

The softening point of the adhesive of the present invention may vary over a wide range, depending on the application, in a known way. According to preferred embodiments of the present invention, the Ring & Ball softening point of the adhesive composition is between about 50° C. and about 150° C., preferably between about 55° C. and about 140° C., more preferably between about 60° C. and about 135° C., and most preferably between about 65° C. and about 130° C. Ring & Ball softening points were determined herein with an automated Herzog unit according to the method set forth in ASTM E-28.

The crossover temperature of the adhesive of the present invention may vary over a wide range, depending on the application, in a known way. According to preferred embodiments of the present invention, the crossover temperature of the adhesive composition is at least 45° C., preferably at least 50° C., and most preferably at least 58° C. The crossover temperature, also identified as Tₓ, is defined as the highest temperature at which the storage modulus, G′, and loss modulus, G″, intersect as measured using dynamic mechanical analysis (DMA) of the adhesive while cooled from the molten to solid state. The test method used is ASTM D 4440-01, with a cooling rate of 10° C./min.

The hot melt pressure sensitive adhesive composition of the present invention may be formulated using any technique known in the art. A representative example of the mixing procedure involves placing all the components in a jacketed mixing vessel equipped with a rotor, and thereafter raising the temperature of the mixture to a range from 120° C. to 230° C. to melt the contents. It should be understood that the precise temperature to be used in this step would depend on the melting points of the particular ingredients. The constituents are individually or in certain combinations introduced to the vessel under agitation and the mixing is allowed to continue until a consistent and uniform mixture is formed.

In an embodiment of the invention, the adhesive is made using a traditional overhead mixer at about 180° C. First, the plasticizer, tackifier, and any antioxidant(s) are heated to desired temperature under an inert blanket and stirring is started for homogeneity. Then, the block copolymer is added. Mixing while applying heat is continued until the mix is homogenous and the polymer is melted. Other conventional methods may be used to make the hot melt pressure sensitive adhesive of the present invention. For example, methods employing static mixing, single screw extrusion, twin screw extrusion, and kneading, may be used. The hot melt pressure sensitive adhesive is then cooled to room temperature and formed into chubs with a protective skin formed thereon or into other suitable packages shipment and use.

The resulting hot melt pressure sensitive adhesive may then be applied to substrates using a variety of coating techniques. Examples include hot melt slot die coating, hot melt wheel coating, hot melt roller coating, melt-blown coating as well as slot, spiral spray, and wrapping spray methods such as those used to affix elastic strands. Spray techniques are numerous and can be done with or without assistance of compressed air that would shape the adhesive spray pattern. The hot melt pressure sensitive adhesive material is generally pumped molten through hoses to the final coating spot on the substrates. Any application temperature above the softening point of the adhesive formulation is suitable.

The hot melt pressure sensitive adhesive composition of the present invention may be used in a number of applications such as, for example, in disposable nonwoven hygienic articles, paper converting, flexible packaging, wood working, carton and case sealing, labeling and other assembly applications. Particularly preferred applications include diaper and adult incontinent brief elastic attachment, disposable diaper and feminine sanitary napkin construction, diaper and napkin core stabilization, diaper backsheet lamination, industrial filter material conversion, surgical gown and surgical drape assembly. It has been found that the adhesive of the invention is particularly useful as a general purpose label adhesive.

The adhesive of the present invention can also be used with any application where various substrate materials are involved. Examples include nonwoven materials and polymeric films. Any substrate material and any substrate form could be used in any combination possible with the adhesive serving to bond a single substrate folded over on itself or two or more substrates together. The substrates can be of multiple forms, for example fiber, film, thread, strip, ribbon, tape, coating, foil, sheet, and band. The substrate can be of any known composition for example polyolefin, polyacrylic, polyester, polyvinyl chloride, polystyrene, cellulosic like wood, cardboard, or paper. The bulk substrate's mechanical behavior can be rigid, plastic, or elastomeric. The above lists are not limiting or all-inclusive, but are only provided as common examples.

In an embodiment of the invention, a method of making a laminate comprises the step of applying the hot melt pressure sensitive adhesive composition of the invention in a molten state to a primary substrate. In this embodiment, the laminate may be a tape or label and consists of the primary substrate serving as the backing for the tape or face for the label and the adhesive. In other embodiments, the method for making the laminate further comprises mating a secondary substrate to the primary substrate by contacting the secondary substrate with the adhesive composition before the adhesive is fully cooled. Upon allowing the adhesive to cool, the adhesive bonds the primary substrate to the secondary substrate. In embodiments in which the adhesive is suitable for use as a construction adhesive, the primary substrate may be a polyolefin film, such as polyethylene, and the secondary substrate may be a nonwoven material or layer.

In alternative embodiments of the invention, the adhesive is applied to the first substrate using a direct contact method of hot melt application, such as a slot or V-slot applicator head. Alternatively, the adhesive may be applied to the first substrate using a non-contact method of hot melt, such as a spray applicator.

### Aspects of the Invention

Aspect 1. A hot melt pressure sensitive adhesive composition comprising:
(a) a block copolymer comprising a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min, preferably between about 0.1 and about 200 g/10 min, more preferably between about 0.5 and about 100 g/10 min, and most preferably between about 1 and about 50 g/10 min;
(b) a tackifying resin; and
(c) a plasticizer.
Aspect 2. The composition of Aspect 1, wherein the block copolymer has a structure of formula (I):

[P1ₐ-P2_{b}]ₙ (I)
wherein P1 is the first polymer block, P2 is the second polymer block, a indicates the number of the first polymer blocks within the structural unit [P1ₐ-P2_{b}] and is from 1 to 5, b indicates the number of the second polymer blocks within the structural unit [P1ₐ-P2_{b}] and is from 1 to 5, and n indicates the number of the structural units within the block copolymer and is from 1 to 5.
Aspect 3. The composition of Aspects 1 or 2, wherein the C₁ to C₄ alkyl acrylate is selected from the group consisting of methyl acrylate and butyl acrylate.
Aspect 4. The composition of any of Aspects 1-3, wherein the block copolymer comprises a first block copolymer wherein the C₁ to C₄ alkyl acrylate is methyl acrylate and a second block copolymer wherein the C₁ to C₄ alkyl acrylate is butyl acrylate.
Aspect 5. The composition of any of Aspects 1-4, wherein the C₁ to C₄ alkyl acrylate comprises methyl acrylate and the block copolymer comprises methyl acrylate residue in an amount of between about 7.5 and about 35 wt %, preferably between about 10 and about 30 wt %, and most preferably between about 24 and about 30 wt %.
Aspect 6. The composition of any of Aspects 1-5, wherein the C₁ to C₄ alkyl acrylate comprises butyl acrylate and the block copolymer comprises butyl acrylate residue in an amount of between about 15 and about 40 wt %, preferably between about 17 and about 35 wt %, and most preferably between about 27 and about 35 wt %.
Aspect 7. The composition of any of Aspects 1-6, wherein the crossover temperature of the composition is at least 45° C., preferably at least 50° C., and most preferably at least 58° C.
Aspect 8. The composition of any of Aspects 1-7, wherein:
   the block copolymer is present in an amount of between about 15% and about 40%, preferably between about 20% and about 35%, more preferably between about 22% and about 32%, and most preferably between about 25% and about 30%, by weight;
   the tackifying resin is present in an amount of between about 30% and about 75%, preferably between about 35% and 70%, more preferably between about 38% and 60%, and most preferably between about 40% and about 55%, by weight; and
   the plasticizer is present in an amount of between about 5% and about 40%, preferably between about 10% and about 35%, more preferably between about 15% and 30%, and most preferably between about 18% and about 27%.
Aspect 9. The composition of any of Aspects 1-8, wherein the plasticizer and the tackifier have a polarity adapted to selectively be miscible with the first polymer block.
Aspect 10. The composition of any of Aspects 1-9, wherein:
   the plasticizer is selected from the group consisting of an isobutylene/butene copolymer and a mineral oil comprising non-polar aliphatic and alicyclic hydrocarbons; and
   the tackifier is selected from the group consisting of a hydrogenated C₅ aliphatic resin and an unhydrogenated C₅ aliphatic resin.
Aspect 11. The composition of any of Aspects 1-8, wherein the plasticizer and the tackifier have a polarity adapted to selectively be miscible with the second polymer block.
Aspect 12. The composition of any of Aspects 1-8, wherein:
   the plasticizer comprises a benzoate ester; and
   the tackifier comprises a rosin ester.
Aspect 13. The composition of any of Aspects 1-12, wherein the viscosity of the composition is between about 1,000 cP and about 250,000 cP at 163° C., preferably between about 2,000 cP and about 150,000 cP at 163° C., more preferably between about 3,000 cP and about 100,000 cP at 163° C., and most preferably between about 4,000 cP and about 50,000 cP at 163° C.
Aspect 14. The composition of any of Aspects 1-13 having a Ring & Ball softening point of between about 50° C. and about 150° C., preferably between about 55° C. and about 140° C., more preferably between about 60° C. and about 135° C., and most preferably between about 65° C. and about 130° C.
Aspect 15. The composition of any of Aspects 1-14 further comprising a stabilizer or antioxidant.
Aspect 16. The composition of any of Aspects 1-15 further comprising a wax.
Aspect 17. The composition of any of Aspect 16, wherein the wax is present in the amount between about 0.1% and about 20% by weight.
Aspect 18. A method of making a laminate comprising the step of applying the hot melt pressure sensitive adhesive composition of any of Aspects 1 to 17 in a molten state to a primary substrate.
Aspect 19. The method of Aspect 18, wherein the laminate is a tape or label.
Aspect 20. The method of Aspect 18 further comprising mating a secondary substrate to the first substrate by contacting the secondary substrate with the adhesive composition.
Aspect 21. The method of any of Aspects 18-20, wherein the primary substrate is a polyethylene film.
Aspect 22. The method of Aspects 20 or 21, wherein the secondary substrate is a non-woven layer.
Aspect 23. A laminate made by the methods of any of Aspects 18-22.

### Examples

The following examples demonstrate several aspects of certain preferred embodiments of the present invention, and are not to be construed as limitations thereof.

In the examples below, hot melt pressure sensitive adhesive compositions according to the invention were prepared and characterized via rheological measurements, tack measurements, peel strength measurements, and shear adhesion failure temperature (SAFT) measurements to evaluate and qualify pressure sensitivity. The compositions generally comprised an ethylene-methyl acrylate block copolymer (20-30 formula wt %), a plasticizer (20-30 formula wt %), a tackifying resin (40-55 formula wt %), and an antioxidant (0.2-0.3 formula wt %). The hot melt pressure sensitive adhesive compositions were compounded at 350° F. or greater for 1.5 to 2.5 hours. The adhesive formulations of the invention were compared to those containing a random (non-blocky) ethylene-methyl acrylate copolymer to evaluate improvements in adhesive and thermal properties due to the block architecture of the polymer.

A hot melt pressure sensitive adhesive composition, Example 1, comprising an ethylene-methyl acrylate block copolymer (Lotryl 29MA03T), a rosin ester tackifier (Sylvalite RE 100L), a benzoate ester plasticizing oil (Benzoflex 9-88), and a phenolic primary antioxidant (Irganox 1010) was made using the formula shown in Table 1.

TABLE 1

| Material name | wt % |
|---|---|
| Lotryl 29MA03T | 28 |
| Benzoflex 9-88 | 24.9 |
| Sylvalite RE | |
| 100L | 46.9 |
| Irganox 1010 | 0.2 |
| Total | 100 |

Benzoflex 9-88, Sylvalite RE 100L, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 1 to 1.5 hours at 250-300 rpm. The final adhesive was removed from the heating mantle and poured into a mold to produce a sample for viscosity testing.

A hot melt pressure sensitive adhesive composition, Example 2, comprising an ethylene-methyl acrylate block copolymer (Lotryl 29MA03T), rosin ester tackifier (Sylvalite RE 100L), a benzoate ester plasticizing oil (Benzoflex 50), and a phenolic primary antioxidant (Irganox 1010) was made using the formula shown in Table 2.

TABLE 2

| Material name | wt % |
|---|---|
| Lotryl 29MA03T | 28 |
| Benzoflex 50 | 24.9 |
| Sylvalite RE | |
| 100L | 46.9 |
| Irganox 1010 | 0.2 |
| Total | 100 |

Benzoflex 50, Sylvalite RE 100L, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 1 to 1.5 hours at 250-300 rpm. The final adhesive was removed from the heating mantle and poured into a mold to produce a sample for viscosity testing.

A hot melt pressure sensitive adhesive composition, Example 3, comprising an ethylene-methyl acrylate block copolymer (Lotryl 29MA03T), an aliphatic C5 hydrocarbon tackifying resin, a white mineral oil (Hydrobrite 550 P.O.), and an antioxidant (Irganox 1010) was made using the formula shown in Table 3.

TABLE 3

| Material name | % |
|---|---|
| Lotryl 29MA03T | 28 |
| Hydrobrite 550 PO | 24.9 |
| Piccotac 1095 | 46.9 |
| Irganox 1010 | 0.2 |
| Total | 100 |

Hydrobrite 550 PO, Piccotac 1095, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 2 hours at 250-300 rpm. The final adhesive was removed from the heating mantle and poured into a mold to produce a sample for viscosity testing.

A hot melt pressure sensitive adhesive composition, Example 4, comprising an ethylene-methyl acrylate block copolymer (Lotryl 29MA03T), rosin ester (Sylvalite RE 100L), a benzoate ester plasticizing oil (Benzoflex 9-88), and an antioxidant (Irganox 1010) was made using the formula shown in Table 4. The formula was modified from Example 1 in an effort to increase the peel strength and tack of the adhesive.

TABLE 4

| Material name | % |
|---|---|
| Lotryl 29MA03T | 25 |
| Benzoflex 9-88 | 24 |
| Sylvalite RE | 50.8 |
| 100L | |
| Irganox 1010 | 0.2 |
| Total | 100 |

Benzoflex 9-88, Sylvalite RE 100L, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 1 to 1.5 hours at 250-300 rpm. The final adhesive was removed from the heating mantle and poured into a mold to produce a sample for viscosity testing.

Each of Examples 1-4 were measured on an ARES rheometer. Temperature sweeps were run from 140° C. to −40° C. at 10 rad/sec on 25 mm parallel plates. The glass transition temperature (T_{g}) and the crossover temperature (Tₓ) were determined and are shown in Table 5 below.

TABLE 5

| Example | T_{g} (° C.) | Tₓ (° C.) |
|---|---|---|
| 1 | 5.7 | 62.7 |
| 2 | 2.9 | 64.5 |
| 3 | 9.2 | 61.3 |
| 4 | 10.5 | 62.5 |

The viscosities (in centipoise) of Examples 1-4 were determined using a Brookfield viscometer. Viscosity measurements were taken at 300° F., 325° F., and 350° F. The results are shown in Table 6 below.

The formulas were coated at approximately 1 mil onto PET film. The viscosities of the samples were used to determine the appropriate coating temperature. The samples were coated on a hot melt, slot die coater with a 2 inch wide web.

The 180° peel strengths and loop tacks of the coated samples were determined using the PSTC-101 and PSTC-16 standard test methods respectively. Briefly, the coated samples were cut to strips 1 inch wide and 7 inches long. The test strips and stainless steel test panels (cleaned with acetone) were conditioned in a controlled environment (23±1° C. and 50±5% RH). The samples were prepped by applying the tape to the test panels at a length of approximately 1 inch. A mechanical roller was used to press the tape to panel at 12 inches/minute. The tape was allowed to dwell on the substrate for 15-20 minutes. The panel was placed in the bottom jaw of an instron machine and the tail of the tape sample was clamped into the top jaw of the machine. The sample was peeled at 180° at 12 inches/minute and the peel strength was recorded. The results are shown in Table 6 below.

Loop tack measurements were performed on clean stainless steel plates. The plates were placed in a jig parallel with the floor. A loop was created with the remaining 6 inches of the tape sample and was secured into the top jaw of the machine. The loop tack test was performed at 12 inches/minute and the results recorded. The results are shown in Table 6 below.

TABLE 6

| | | | Viscosity | Viscosity |
|---|---|---|---|---|
| | Peel | Loop tack | at 325° F. | at 350° F. |
| Example | (lbs/in) | (lbs/in) | (cP) | (cP) |
| 1 | 4.8 | 5.3 | 27125 | 14800 |
| 2 | 3.5 | 5.7 | 29300 | 17550 |
| 3 | 3.5 | 5.6 | 5925 | 3530 |
| 4 | 7.0 | 8.0 | 20000 | 9200 |

The data in Table 6, especially when comparing Example 4 to Example 1, revealed an increase in the adhesive performance (i.e., peel and tack) of a formulation having a slight increase in the amount of tackifier.

SAFT was determined using the PSTC-17 standard test method. Briefly, the coated samples were cut into strips 3 inches long and 1 inch wide. The test strips and stainless steel test panels (cleaned with acetone) were conditioned in a controlled environment (23±1° C. and 50±5% RH). The samples were manually applied to the test panels with a specimen size of 1 inch wide and inch long. A clip was applied to the tail of the tape sample. The samples were placed in an oven, a 1000 gram weight was hung from each of the clips, and the samples were heated to 300° F. at a ramp rate of approximately 3°/minute. The instrument detected when the weights fell and the time and temperature where recorded by the data-logger.

TABLE 7

| Example | SAFT (° F.) |
|---|---|
| 1 | 136 |
| 2 | 121 |
| 3 | 100 |
| 4 | 133 |

These results in Table 7 show adhesives having suitable SAFT values for many applications. The adhesives of Examples 1, 2, and 4 include polar tackifiers and plasticizers, which led to SAFT values and consequently adhesives which demonstrate better thermal resistance. The adhesive of Example include non-polar tackifiers and plasticizers, which led to a lower SAFT value, but one which would be suitable for applications not requiring a thermally-resistant adhesive.

Formulations containing the block copolymer vs the random copolymer (no blocks) were compared to determine if the block copolymer provides improved temperature resistance. The random copolymer formulas were compared to block copolymer formulations 1 and 3. A hot melt pressure sensitive adhesive composition, Comparative Example 1, comprising an ethylene-co-methyl acrylate random copolymer (Lotryl 29MA03), rosin ester (Sylvalite RE 100L), a benzoate ester plasticizing oil (Benzoflex 9-88), and a primary phenolic antioxidant (Irganox 1010) was made using the formula shown in Table 8 below.

TABLE 8

| Material name | wt % |
|---|---|
| Lotryl 29MA03 | 28 |
| Benzoflex 9-88 | 24.9 |
| Sylvalite RE | 46.9 |
| 100L | |
| Irganox 1010 | 0.2 |
| Total | 100 |

Benzoflex 9-88, Sylvalite RE 100L, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 1 to 1.5 hours at 250-300 rpm. The final adhesive was removed from the heating mantle and poured into a mold to produce a sample for viscosity testing.

A hot melt pressure sensitive adhesive composition, Comparative Example 2, comprising an ethylene-co-methyl acrylate random copolymer (Lotryl 29MA03), aliphatic C5 hydrocarbon resin (Piccotac 1095), a white mineral oil (Hydrobrite 550 P.O.), and an antioxidant (Irganox 1010) was made using the formula shown in Table 9 below.

TABLE 9

| Material name | grams | % |
|---|---|---|
| Lotryl 29MA03 | 70 | 28 |
| Hydrobrite 550 PO | 62.25 | 24.9 |
| Piccotac 1095 | 117.25 | 46.9 |
| Irganox 1010 | 0.5 | 0.2 |
| Total | 250 | 100 |

Hydrobrite 550 P.O., Piccotac 1095, and Irganox 1010 were combined in a pint-sized paint can. The materials were heated in a heating mantle with the temperature set to 350° F. under a nitrogen blanket. When the resin was molten, the materials were stirred at 75 rpm using an overhead stirrer. Once the temperature reached approximately 300° F., the polymer was slowly added and the stirrer speed was slowly increased up to 250 rpm. The mix was left to stir for approximately 1 to 1.5 hours at 250-300 rpm. The final adhesive was removed from the heating mantle and poured into a mold to produce a sample for viscosity testing.

The samples were coated and tested according to the previously mentioned procedures. The results of the rheological measurements and SAFT, shown in Table 10 below, indicated an increase in temperature resistance of the formulas containing the block copolymer. Rheological analysis showed an increase in crossover temperature of the block copolymer-containing adhesives. The SAFT values of the block copolymer-containing adhesives were higher than those of the random copolymer-containing adhesives. Both of these results would lead to better high temperature performance of the block copolymer-containing adhesives.

TABLE 10

| Formula | Tₓ (° C.) | SAFT (° F.) |
|---|---|---|
| 1 | 62.7 | 136 |
| 3 | 61.3 | 100 |
| CE 1 | 45.0 | 125 |
| CE 2 | 43.1 | 91 |

Evaluation of different plasticizers and tackifiers revealed better adhesion is achievable through exploitation of the ethylene domains/blocks or the acrylate domains/blocks. Formulations were attempted with combinations of rosin ester and C5 (aliphatic) resin, using C9 (aromatic) resin, C5 resin and benzoate ester plasticizer, C5 and napthenic oil, and rosin ester and napthenic oil, but these combinations resulted in formulations which performed poorly and/or did not exhibit pressure sensitive properties due to incompatibility (poor or mismatched solubility) of the raw materials.

Below are experiments with different plasticizers and tackifiers which resulted in adhesives with pressure sensitive properties. Comparison of similar formulas containing Lotryl 29MA03T, rosin ester tackifier (Sylvalite RE 100L), and phenolic primary antioxidant (Irganox 1010), and but with different benzoate plasticizers were made, as shown in Table 11

TABLE 11

| | T_{g} | Tₓ | Peel | Loop tack |
|---|---|---|---|---|
| Plasticizer | (° C.) | (° C.) | (lb/in) | (lb/in) |
| Benzoflex 9-88 | 5.7 | 62.7 | 4.8 | 5.3 |
| (benzoate esters) | | | | |
| Benzoflex 50 | 2.9 | 64.5 | 3.5 | 5.7 |
| (benzoate esters) | | | | |
| Benzoflex 131 | −1 | 69.6 | 0.5 | 1.7 |
| (isodecyl benzoate) | | | | |

Table 11 shows similar performance between adhesives containing Benzoflex 9-88 and Benzoflex 50, which are both benzoate esters. There is a drop in T_{g} and an increase in Tₓ with the use of Benzoflex 131, suggesting that the plasticizer might solvate the polymer better, but the tack and peel performance is lower which might suggest some incompatibility with the tackifier (rosin ester). However, all three exhibit pressure sensitive properties with a range of performances.

Table 12 shows two different tackifiers used in formulas containing Lotryl 29MA03T. These formulations also contained a white mineral oil (Hydrobrite 550 P.O.) and phenolic primary antioxidant (Irganox 1010) in the same weight percentages.

TABLE 12

| | Peel | Loop tack | SAFT* |
|---|---|---|---|
| Tackifier | (lb/in) | (lb/in) | (° F.) |
| Piccotac 1095 (C5 resin) | 3.5 | 5.6 | 100 |
| Eastotac H-100R | 3.4 | 3 | 105 |
| (hydrogenated C5 resin) | | | |

*SAFT—shear adhesion failure temperature

Table 12 shows comparable PSA performance between similar formulations containing two different C5 resins. A resin with a softening point between 90° C. and 110° C. is preferable for the adhesive to exhibit pressure sensitive properties. A formulation containing a hydrogenated C5 with a softening point of 130° C. resulted in an adhesive which was not as tacky as the ones in the above table.

Evaluation of different additives to observe effects on adhesion and low temperature performance (i.e. lower T_{g}).

Three additives were evaluated to determine if they could be used to improve raw material compatibility and lower T_{g} of the adhesive. Additions of two of the three additives were successful and the formulations were analyzed.

As shown in Table 13, a comparison of similar formulas was made containing Lotryl 29MA03T polymer, Benzoflex 9-88 plasticizer, and an additive which was substituted in for some of the plasticizer, namely in an amount of 10 wt % Ionet DO-400 and 6 wt % Indopol H-100.

TABLE 13

| Additive | T_{g} (° C.) | Tₓ (° C.) |
|---|---|---|
| None (control for Ionet additive) | 5.7 | 62.7 |
| Ionet DO-400 (polyoxethylene dioleate; | −2.4 | 62.8 |
| emulsifying agent and dispersant) | | |
| None (control for Indopol additive) | 5.9 | 65.5 |
| Indopol H-100 (liquid polybutene; | 3.2 | 65.4 |
| plasticizer) | | |

Table 13 shows these additives lower the T_{g} which relates to better performance of the adhesives at lower temperatures.

As shown in Table 14, a comparison was made of a control formula with Lotryl 29MA03T polymer and benzoate ester plasticizer and a formula containing the same polymer and plasticizer but with Indopol H-100 added in in an amount of 5 wt %.

TABLE 14

| Additive | Peel (lb/in) | Loop tack (lb/in) |
|---|---|---|
| None (control) | 4.8 | 5.3 |
| Indopol H-100 | 5.2 | 5.1 |

Table 14 shows addition of Indopol H-100 not only lowers the T_{g} but does not significantly affect the adhesion performance compared to a control. Visual observation of the adhesive containing the Indopol revealed a slightly clearer adhesive which indicates that the Indopol may help to improve compatibility of the raw materials in the formulation.

Calcium carbonate (CaCO₃) is sometimes added to adhesives as a filler to reduce cost and can help, if enough is added, to lower adhesive odor. As shown in Table 15, comparisons were made of a control formula with Lotryl 29MA03T and mineral oil plasticizer and a formula containing the same polymer and plasticizer but with 3% CaCO₃ added.

TABLE 15

| Additive | Peel (lb/in) | Loop tack (lb/in) | SAFT (° F.) |
|---|---|---|---|
| None (control) | 3.4 | 3 | 105 |
| CaCO₃ | 2.9 | 1.6 | 101 |

Table 15 shows addition of 3% filler was shown to only slightly reduce adhesion and SAFT as expected.

Tests were run to compare the use of an ethylene butyl acrylate (EBA) copolymer to an ethylene methyl acrylate copolymer (EMA). The EBA copolymer has lower mechanical strength and slightly lower temperature resistance than the EMA copolymer. This could lend to a softer adhesive with lower T_{g}. T_{g} and Tₓ of adhesives containing Lotryl 35BA40T or a blend of Lotryl 29MA03T and Lotryl 35BA40T are shown below in Table 16.

TABLE 16

| Polymer(s) | T_{g} (° C.) | Tₓ (° C.) |
|---|---|---|
| 35BA40T | −2.4 | 62.0 |
| 29MA03T:35BA40T (50:50) | 0.6 | 62.3 |
| 29MA03T:35BA40T (70:30) | 1.8 | 63.4 |

Table 16 shows formulations containing 35BA40T have lower T_{g} values than a comparable formula containing only 29MA03T with a T_{g} of about 5.7° C.

Evaluation of adhesion (peel strength and loop tack) and SAFT of a formula containing Lotryl 35BA40T, a C5 resin, and a mineral oil plasticizer and a formula containing the same plasticizer and resin but with Lotryl 29MA03T polymer were made and reported in Table 17.

TABLE 17

| Polymer | Peel (lb/in) | Loop tack (lb/in) | SAFT (° C.) |
|---|---|---|---|
| 35BA40T | 4.8 | 8.3 | 103 |
| 29MA03T | 3.5 | 5.6 | 100 |

Table 17 shows the softer 35BA40T polymer seems to promote adhesion and tackiness of the adhesive versus the 29MA03T. This is also evident in the results of peel adhesion and loop tack on lower surface energy substrates like high density polyethylene (HDPE) and polypropylene (PP).

A comparison of adhesion on LSE surfaces was made and the results are shown in Table 18. In particular, similar formulas containing a C5 resin and a mineral oil plasticizer but different polymers were made and tested.

TABLE 18

| Polymer | Substrate | Peel (lb/in) | Loop tack (lb/in) |
|---|---|---|---|
| 29MA03T | HDPE | 2.8 | 2.4 |
| 35BA40T | HDPE | 4.6 | 7.7 |
| 29MA03T | PP | 3.0 | 2.6 |
| 35BA40T | PP | 4.3 | 5.4 |

Table 18 shows good adhesion of both adhesives to low surface energy substrates, but higher peel strength and tack of formulations containing the softer EBA block copolymer (35BA40T).

Where a range of values is provided, it is understood that each intervening value, and any combination or sub-combination of intervening values, between the upper and lower limit of that range and any other stated or intervening value in that stated range, is encompassed within the range of values recited. In addition, the invention includes a range of a constituent which is the lower limit of a first range and an upper limit of a second range of that constituent.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue or prior invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. A hot melt pressure sensitive adhesive composition comprising:
(a) a block copolymer comprising a first polymer block comprising an ethylene residue and a second polymer block comprising a C₁ to C₄ alkyl acrylate residue, wherein the block copolymer has a melt index as measured in accordance with ASTM D1238 of between about 0.1 and about 250 g/10 min;
(b) a tackifying resin; and
(c) a plasticizer.

2. The composition of claim 1, wherein the block copolymer has a structure of formula (I):
[P1ₐ-P2_{b}]ₙ (I)
wherein P1 is the first polymer block, P2 is the second polymer block, a indicates the number of the first polymer blocks within the structural unit [P1ₐ-P2_{b}] and is from 1 to 5, b indicates the number of the second polymer blocks within the structural unit [P1ₐ-P2_{b}] and is from 1 to 5, and n indicates the number of the structural units within the block copolymer and is from 1 to 5.

3. The composition of claim 1, wherein the C₁ to C₄ alkyl acrylate is selected from the group consisting of methyl acrylate and butyl acrylate.

4. The composition of claim 1, wherein the block copolymer comprises a first block copolymer wherein the C₁ to C₄ alkyl acrylate is methyl acrylate and a second block copolymer wherein the C₁ to C₄ alkyl acrylate is butyl acrylate.

5. The composition of claim 2, wherein the C₁ to C₄ alkyl acrylate comprises methyl acrylate and the block copolymer comprises methyl acrylate residue in an amount of between about 7.5 and about 35 wt %.

6. The composition of claim 2, wherein the C₁ to C₄ alkyl acrylate comprises butyl acrylate and the block copolymer comprises butyl acrylate residue in an amount of between about 15 and about 40 wt %.

7. The composition of claim 1, wherein the crossover temperature of the composition is at least 45° C.

8. The composition of claim 1, wherein:
the block copolymer is present in an amount of between about 15% and about 40%, by weight;
the tackifying resin is present in an amount of between about 30% and about 75%, by weight; and
the plasticizer is present in an amount of between about 5% and about 40%, by weight.

9. The composition of claim 1, wherein the plasticizer and the tackifier have a polarity adapted to selectively be miscible with the first polymer block.

10. The composition of claim 1, wherein:
the plasticizer is selected from the group consisting of an isobutylene/butene copolymer and a mineral oil comprising non-polar aliphatic and alicyclic hydrocarbons; and
the tackifier is selected from the group consisting of a hydrogenated C₅ aliphatic resin and an unhydrogenated C₅ aliphatic resin.

11. The composition of claim 1, wherein the plasticizer and the tackifier have a polarity adapted to selectively be miscible with the second polymer block.

12. The composition of claim 1, wherein:
the plasticizer comprises a benzoate ester; and
the tackifier comprises a rosin ester.

13. The composition of claim 1, wherein the viscosity of the composition is between about 1,000 cP and about 250,000 cP at 163° C.

14. The composition of claim 1 having a Ring & Ball softening point of between about 50° C. and about 150° C.

15. (canceled)

16. (canceled)

17. (canceled)

18. A method of making a laminate comprising the step of applying the hot melt pressure sensitive adhesive composition of claim 1 in a molten state to a primary substrate and allowing the adhesive to cool to form a bond with said primary substrate.

19. The method of claim 18, wherein the laminate is a tape or label.

20. The method of claim 18 further comprising mating a secondary substrate to the primary substrate by contacting the secondary substrate with the adhesive composition while the adhesive is in a molten state.

21. The method of claim 18, wherein the primary substrate is a polyethylene film.

22. The method of claim 20, wherein the secondary substrate is a non-woven layer.

23. A laminate made by the method of claim 18.
